(19) United States
(12) Patent Application Publication
(10) Pub. No.: US 2026/0320436 A1
(43) Pub. Date: Oct. 15, 2026

(54) DATA PROCESSING

(71) Applicant: Tencent Technology (Shenzhen) Company Limited, Shenzhen (CN)

(72) Inventors: Guangping LIANG, Shenzhen (CN); Mingjin DU, Shenzhen (CN); Ran XU, Shenzhen (CN); Zhangxin YE, Shenzhen (CN); Dongyi CEN, Shenzhen (CN); Huichao HU, Shenzhen (CN); Runzeng GUO, Shenzhen (CN); Jinkun HOU, Shenzhen (CN); Jia CHEN, Shenzhen (CN); Ran SHAO, Shenzhen (CN)

(73) Assignee: Tencent Technology (Shenzhen) Company Limited, Shenzhen (CN)

(21) Appl. No.: 19/467,545

(22) Filed: Feb. 2, 2026

Related U.S. Application Data
(63) Continuation of application No. PCT/CN2024/112578, filed on Aug. 16, 2024.

(30) Foreign Application Priority Data
Oct. 13, 2023 (CN) 202311335169.8

(51) Int. Cl. G06N 5/04

(52) U.S. Cl. CPC G06N 5/04

(57) ABSTRACT

Original data related to a question-answer task is obtained. Based on the original data, at least an initial corpus is determined by using a first model, the initial corpus includes a standard question and an answer to the standard question. By using the first model, at least a similar question is determined based on the standard question, a text similarity between the similar question and the standard question satisfies a similarity condition. A corpus database is generated based on at least the initial corpus and the similar question, the corpus database includes at least a corpus including the standard question, the answer to the standard question, and at least the similar question. A second model for performing the question-answer task is trained by using at least the corpus as a training sample. Apparatus and non-transitory computer-readable storage medium counterpart embodiments are also contemplated.

### RELATED APPLICATIONS

The present application is a continuation of International Application No. PCT/CN 2024/112578, filed on Aug. 16, 2024, which claims priority to Chinese Patent Application No. 202311335169.8, filed on Oct. 13, 2023. The entire disclosures of the prior applications are hereby incorporated by reference.

### FIELD OF THE TECHNOLOGY

This disclosure relates to the field of data processing, including a natural language processing technology.

### BACKGROUND OF THE DISCLOSURE

Currently, intelligent customer services are configured for providing users with services in many online customer service and question-answer scenarios, as an alternative to manual services.

In a related technology, the intelligent customer service is generally implemented by using a small model, and the small model mainly relies on a corpus database to provide services for the users. The corpus database includes a large quantity of question-answer pairs, which may be referred to as frequently-asked questions (FAQ) and used as training samples of the small model. Questions in the FAQ are used as model inputs of the training samples, and answers are used as sample labels of the training samples. The small model is trained by using the training samples in the corpus database, so that the small model learns knowledge in the corpus database, and can interact with the users within the knowledge provided by the corpus database.

Richness and accuracy of the corpus database directly affect quality of services that can be provided by the small model as the intelligent customer service. Currently, the corpus database is mainly maintained manually. As a result, both updating efficiency and corpus quality of the corpus database are difficult to satisfy service requirements of the intelligent customer service.

### SUMMARY

To resolve the foregoing technical problems, this disclosure provides a data processing method and a related apparatus, to effectively improve building efficiency and updating efficiency of a corpus database by using a large model, thereby reducing impact of high costs and quality fluctuation caused by manual maintenance.

Some aspects of the disclosure provide a method of data processing. In some examples, original data related to a question-answer task is obtained. Based on the original data, at least an initial corpus is determined by using a first model, the initial corpus includes a standard question and an answer to the standard question. By using the first model, at least a similar question is determined based on the standard question, a text similarity between the similar question and the standard question satisfies a similarity condition. A corpus database is generated based on at least the initial corpus and the similar question, the corpus database includes at least a corpus including the standard question, the answer to the standard question, and at least the similar question. A second model for performing the question-answer task is trained by using at least the corpus as a training sample, the second model has a smaller scale than the first model, the standard question or the similar question are used as an input of the second model, and the answer to the standard question is used as a sample label.

Some aspects of the disclosure provide an apparatus that includes processing circuitry configured to perform the method of data processing.

Some aspects of the disclosure also provide a non-transitory computer-readable storage medium storing instructions which when executed by at least one processor cause the at least one processor to perform the method of data processing.

Embodiments of this disclosure disclose the following technical solutions.

In an aspect, embodiments of this disclosure provide a data processing method, performed by a computer device. The method includes: obtaining original data related to a question-answer task; determining, based on the original data, a corresponding initial corpus by using a first model, the initial corpus including a standard question and an answer corresponding to the standard question; determining, based on the standard question, a corresponding similar question by using the first model, a text similarity between the similar question and the standard question that have a correspondence satisfying a similarity condition; generating a corpus database based on the initial corpus and the similar question corresponding to the standard question in the initial corpus, corpora in the corpus database including the standard question, the answer corresponding to the standard question, and the similar question, the corpora in the corpus database being used as a training sample to train a second model configured for performing the question-answer task, a scale of the second model being smaller than that of the first model, the standard question or the similar question in the training sample being used as an input of the second model, and the answer corresponding to the standard question in the training sample being used as a sample label; and training the second model by using the training sample, a trained second model being configured for generating a corresponding reply answer to a user question obtained from the question-answer task.

In an aspect, embodiments of this disclosure provide a data processing apparatus. The apparatus includes an obtaining unit, a determining unit, a generation unit, and a training unit.

The obtaining unit is configured to obtain original data related to a question-answer task.

The determining unit is configured to determine, based on the original data, a corresponding initial corpus by using a first model, the initial corpus including a standard question and an answer corresponding to the standard question.

The determining unit is further configured to determine, based on the standard question, a corresponding similar question by using the first model, a text similarity between the similar question and the standard question that have a correspondence satisfying a similarity condition.

The generation unit is configured to generate a corpus database based on the initial corpus and the similar question corresponding to the standard question in the initial corpus, corpora in the corpus database including the standard question, the answer corresponding to the standard question, and the similar question, the corpora in the corpus database being used as a training sample to train a second model configured for performing the question-answer task, a scale of the second model being smaller than that of the first model, the standard question or the similar question in the training sample being used as an input of the second model, and the answer corresponding to the standard question in the training sample being used as a sample label.

The training unit is configured to train the second model by using the training sample, a trained second model being configured for generating a corresponding reply answer to a user question obtained from the question-answer task.

In another aspect, embodiments of this disclosure provide a computer device. The computer device includes a processor (an example of processing circuitry) and a memory.

The memory is configured to store a computer program and transmit the computer program to the processor.

The processor is configured to perform, according to the computer program, the method according to the foregoing aspects.

In another aspect, embodiments of this disclosure provide a computer-readable storage medium (e.g., non-transitory computer-readable storage medium). The computer-readable storage medium is configured to store a computer program, and the computer program is configured for performing the method according to the foregoing aspects.

In another aspect, embodiments of this disclosure provide a computer program product including a computer program. The computer program, when run on a computer device, causes the computer device to perform the method according to the foregoing aspects.

It can be seen from the foregoing technical solutions that, when a question-answer interaction service is provided for the question-answer task, the corpus database needs to be constructed to train the corresponding second model with a small scale, and the standard question, the similar question whose text similarity with the standard question satisfies the similarity condition, and the answer corresponding to the standard question are determined based on the original data related to the question-answer task by using the first model with a large scale. In comparison with the second model, a model service provided by the first model is not limited to knowledge of the used training sample, and has highly efficient semantic understanding and summarization capabilities, so that the standard question and the answer can be accurately extracted from the original data, and the similar question that conforms to a language expression habit can be created based on the text similarity. The corpus database is generated based on the corpus including the standard question, the similar question, and the answer, and the second model is trained based on the corpus database. The second model can provide the question-answer interaction service only within the knowledge of the used training sample, and a high-quality corpus with accuracy and comprehensiveness can be obtained through extraction and creation by using the first model. This reduces impact of high costs and quality fluctuation brought by manual maintenance, so that the second model can generate a high-quality reply answer to the user question obtained from the question-answer task, and building efficiency and updating efficiency of the corpus database can be effectively improved by using the first model.

### BRIEF DESCRIPTION OF THE DRAWINGS

FIG. 1 is a schematic diagram of a data processing scenario according to an embodiment of this disclosure.

FIG. 2 is a method flowchart of a data processing method according to an embodiment of this disclosure.

FIG. 3 is a schematic diagram illustrating a corpus according to an embodiment of this disclosure.

FIG. 4 is a schematic diagram of providing a corpus database for a second model based on a first model according to an embodiment this disclosure.

FIG. 5 is a schematic diagram of corpus generation of a robot question-answer platform according to an embodiment of this disclosure.

FIG. 6 is a structural diagram of a data processing apparatus according to an embodiment of this disclosure.

FIG. 7 is a structural diagram of a terminal device according to an embodiment of this disclosure.

FIG. 8 is a structural diagram of a server according to an embodiment of this disclosure.

### DESCRIPTION OF EMBODIMENTS

The following describes embodiments of this disclosure with reference to the accompanying drawings.

A model precision of a small model configured for providing a question-answer interaction service in online customer service and question-answer scenarios is directly related to quality of a corpus database used as a training sample. In addition, in a related technology, the corpus database is mainly maintained manually. For example, a standard question, an answer, and a similar question are extracted manually. Consequently, manual inefficiency causes both updating efficiency and corpus quality of the corpus database to hardly satisfy a service requirement of an intelligent customer service.

Therefore, embodiments of this disclosure provide a data processing method, to effectively improve building efficiency and the updating efficiency of the corpus database by using a large model, thereby resolving problems of impact of high costs and quality fluctuation caused by manual maintenance.

The data processing method of this disclosure relates to an artificial intelligence technology.

The data processing method of this disclosure mainly relates to directions such as a computer vision technology, a voice processing technology, a natural language processing technology, and machine learning/deep learning. For example, the large model in this disclosure may extract a standard question and an answer from original data based on the computer vision technology, the voice processing technology, the natural language processing technology, and the like, and determine a corresponding similar question based on the standard question. For example, in this disclosure, the small model may be trained, based on a machine learning manner and by using a target corpus in the corpus database as a training sample, so as to serve as an intelligent customer service role in a target question-answer task, thereby providing the question-answer interaction service.

The data processing method provided in embodiments of this disclosure may be implemented by a computer device. The computer device may be a terminal device or a server. The server may be an independent physical server, a server cluster or a distributed system including a plurality of physical servers, or a cloud server that provides a cloud computing service. The terminal device includes but is not limited to a mobile phone, a computer, an intelligent voice interaction device, an intelligent home appliance, a vehicle-mounted terminal, an aircraft, and the like. The terminal device and the server may be directly or indirectly connected in a wired or wireless communication manner, which is not limited in this disclosure.

In some implementations of this disclosure, the obtained original data may involve relevant data such as user information. When the foregoing embodiments of this disclosure are applied to a specific product or technology, a permission or consent of a user is separately required for each of them, and collection, use, and processing of the related data need to comply with relevant laws, regulations, and standards of relevant countries and regions.

First, technical terms that may be involved in embodiments of this disclosure are briefly introduced.

Corpus: The corpus refers to FAQ data configured for training and optimizing an intelligent customer service system (small model), and includes a standard question, an answer, and a similar question.

Standard question: The standard question is a core part of the corpus, is a typical and representative question, and is configured for helping the intelligent customer service system recognize a requirement of a user.

Similar question: The standard question is a question whose meaning is similar to that of the standard question and whose expression manner is slightly different from that of the standard question in the intelligent customer service system or a chatbot.

Intelligent customer service system: The intelligent customer service system is an automated customer service solution based on artificial intelligence technologies, and automatically answers a question of the user or guides the user to complete an operation by simulating a human customer service. In embodiments of this disclosure, the intelligent customer service system is implemented by using the small model.

First model: The first model may also be referred to as a large model, and the large model refers to a neural network model having a large quantity of parameters and a complex structure in the fields of artificial intelligence and deep learning.

Second model: The second model may also be referred to as a small model, and is a neural network model using fewer parameters and a simple structure. When processing a user question and providing an answer, compared with the large model, such a model has relatively low computing complexity and a relatively fast inference speed, and is suitable for being used in a scenario with limited computing resources. The small model is used for the intelligent customer service system.

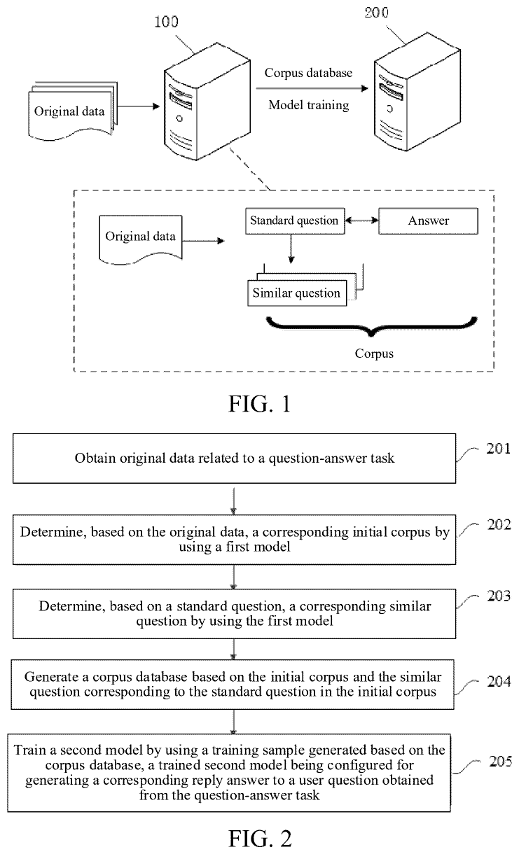

FIG. 1 is a schematic diagram of a data processing scenario according to an embodiment of this disclosure. An example in which a server 100 is used as the foregoing computer device is used. The server 100 is configured with a first model. A server 200 is a server configured to provide a question-answer interaction service for a question-answer task, and the server 200 may be configured with a second model.

For the question-answer task, a corpus database needs to be constructed to train the corresponding second model. Based on original data related to the question-answer task, the server 100 determines, by using the first model, a standard question, a similar question whose text similarity with the standard question satisfies a similarity condition, and an answer to the standard question. In comparison with the second model, a model service provided by the first model is not limited to knowledge of a used training sample, and has highly efficient semantic understanding and summarization capabilities, so that the standard question and the answer can be accurately extracted from the original data, and the similar question that conforms to a language expression habit can be created based on the text similarity. A corpus is formed based on the standard question, the similar question, and the answer, and then, the corpus database is formed based on the corpora obtained in this way.

The server 100 may transmit the corpus database to the server 200, to train the second model. The second model can provide the question-answer interaction service only within the knowledge of the used training sample, and a high-quality corpus with accuracy and comprehensiveness can be obtained through extraction and creation by using the first model, thereby reducing impact of high costs and quality fluctuation caused by manual maintenance. In this way, the second model can generate a high-quality reply answer for a user question obtained from the question-answer task, and building efficiency and updating efficiency of the corpus database can be effectively improved by using the first model.

FIG. 2 is a method flowchart of a data processing method according to an embodiment of this disclosure. The method may be performed by a computer device. In this embodiment, an example in which the computer device is a server is used for description. The method includes:

S201: Obtain original data related to a question-answer task.

The question-answer task may be a data processing task for implementing an intelligent question-answer interaction service in a field, and the field may refer to a product, may refer to a service, or the like.

For example, the intelligent question-answer interaction service may be an intelligent customer service system for a product, may be an intelligent question-answer system or a chatbot for a service, or the like.

The original data is historical data of the field related to the question-answer task, and the historical data carries information related to the field. The information may be extracted and summarized by using a first model, to obtain knowledge related to question-answer interaction.

This disclosure does not limit a content type of the original data. For example, in an implementation example, the original data includes at least one of historical question-answer text data and field knowledge text data related to the question-answer task.

The historical question-answer text data may be content questioned by a user in the field related to the question-answer task by using a social platform such as a forum, social software, or shopping software, and content answered by another professional.

Content of the field knowledge text data may not be in a question-answer form, and may be, for example, a descriptive text or a paper. Because the first model has a semantic understanding capability and an extraction capability, a corresponding standard question and answer may also be extracted from the field knowledge text data by using the first model.

S202: Determine, based on the original data, a corresponding initial corpus by using the first model.

As described above, the first model (large model) and a second model (small model) have essential differences in terms of parameters, structures, and model inference speeds.

In natural language processing mainly related to this embodiment of this disclosure, differences between the first model and the second model are mainly reflected in the following several aspects.

Quantity of parameters: The first model usually has more parameters, while the second model has fewer parameters. The quantity of parameters determines complexity and capacity of the model. Because the first model has more parameters, the first model usually has a stronger expression capability, and can capture more data features. However, an overfitting risk may also be caused.

Quantity of training samples: The first model usually needs more training samples to optimize the parameter, while the second model may use fewer training samples for training. For training of a large amount of data, the first model can usually learn more knowledge and features, but also needs more computing resources and time.

Computing resource and time: The first model needs more computing resources (such as a GPU or a TPU) and time for training and inference. In comparison, the second model needs fewer computing resources and time, and is more suitable for being deployed and used on a device with limited resources.

Performance: The first model usually has better performance on various natural language processing tasks, particularly on a complex task and a large-scale dataset. However, as a model scale increases, performance improvement may gradually approach saturation. In comparison, the second model may have poor performance on a simple task and a small-scale dataset, but is still a viable option in a case that there are limited computing resources.

Applicable scenario: Each of the first model and the second model has an applicable scenario. For the complex task and the large-scale dataset, the first model may be a better option because the first model has a stronger expressive capability and better performance. However, for the simple task, the small-scale dataset, or a scenario with limited computing resources (for example, a target question-answer task), the second model may be a better option because the second model needs fewer computing resources and less time.

In conclusion, a model with 1 billion to 3 billion or more parameters and a strong text generation capability can be considered as the first model, that is, the large model.

Knowledge learned by the first model enables the first model to provide a service beyond the knowledge in the training sample. That is, the first model has linguistic-level organization, summarization, and creative capabilities. However, a scope of content that the second model can output is limited to the knowledge in the training sample. That is, the second model does not have specific linguistic-level organization, summarization, and creative capabilities, and the scope of the content that can be outputted does not exceed a scope of an answer in the training sample. The output scope for the second model is mainly based on substantive content. In some cases, the second model may alternatively add non-substantive content, for example, a modal particle and a particle, to the substantive content, to improve user interaction experience.

In this embodiment of this disclosure, question-answer extraction mainly means analyzing the original data by using the capability of the first model and adjusting, with reference to an appropriate prompt, a model parameter by using contextual understanding, semantic analysis, and summarization and extraction capabilities of the first model, to effectively extract a standard question suitable for training of the second model and an answer corresponding to the standard question. The standard question and the corresponding answer may form an initial corpus.

For example, the original data is historical question-answer text data. Details are as follows:

User A: I'd like to make an inquiry

User A: Generally, how to effectively extract an intelligent customer service corpus

User B: Hello, there are currently many methods

User B: A common manner in the industry is XXX

The standard question and the answer that are in the corresponding initial corpus and that are obtained by using the large model are respectively as follows: [{“question”: “how to extract the intelligent customer service corpus”, “answer”: “the common manner is XXX”}]

S203: Determine, based on the standard question, a corresponding similar question by using the first model.

The determined corpus is mainly configured for training the second model. To enable the second model to learn knowledge in the corpus, a specific quantity of training samples is needed. When there are insufficient training samples, an underfitting problem occurs.

However, for a standard question and an answer in an initial corpus, a quantity of generated training samples is excessively small. If similar question generalization is not performed, it is difficult for the second model to learn the knowledge of the initial corpus based only on the standard question and the answer during training.

Therefore, in this disclosure, with help of the semantic understanding and extraction capabilities of the first model, the similar question of the standard question is further generated by using the first model based on a text similarity as generalization guidance. A text similarity between the generated similar question and the corresponding standard question satisfies a similarity condition.

As described above, a meaning of the similar question is similar to that of the standard question, but an expression manner of the similar question is slightly different that of the standard question. That is, the standard question and the corresponding similar question are both configured for asking the same question, but differ in terms of expression forms and sentence structures.

For example, the standard question is: “How to effectively extract an intelligent customer service?”. The similar question generated by using the first model and based on the text similarity as the generalization guidance may include: “What are effective manners to extract an intelligent customer service corpus?”, “How can an intelligent customer service corpus be effectively extracted?”, “By what means can an intelligent customer service corpus be effectively extracted?”, and the like.

Based on the similar question obtained through generalization, the training sample related to the standard question may be effectively expanded. For example, a training sample is formed by using a similar question and an answer corresponding to a standard question. In this way, it is ensured that the second model learns necessary knowledge during training.

S204: Generate a corpus database based on the initial corpus and the similar question corresponding to the standard question in the initial corpus.

A corpus in the corpus database includes the standard question, the answer corresponding to the standard question, and the similar question corresponding to the standard question, and the corpus in the corpus database is used as a training sample to train the second model configured for performing the question-answer task.

In a training process, the answer to the standard question is used as a sample label for both the standard question and the corresponding similar question. For ease of maintenance, in this embodiment of this disclosure, the training sample is maintained in a form of the corpus database, and the standard question, the similar question corresponding to the standard question, and the answer corresponding to the standard question are all carried in the same corpus, so that when the second model needs to be trained, the training sample may be generated based on the corpus in the corpus database.

The standard question or the similar question in the training sample is used as an input of the second model, and the answer corresponding to the standard question in the training sample is used as the sample label.

It is emphasized again that, as described above, the second model is configured for providing a question-answer interaction service within the knowledge of the used training sample, and the model service provided by the first model is not limited to the knowledge of the used training sample.

S205: Train the second model by using the training sample, a trained second model being configured for generating a corresponding reply answer to a user question obtained from the question-answer task.

Because high efficiency and timeliness are needed for the intelligent customer service, currently, the second model is used for an intelligent customer service in the industry, and a core of the second model is training by using the corpus database. As long as the corpus database is rich enough, various questions of a user can be covered. In addition, a training period of the second model is short, and rapid iterative upgrade can be rapidly performed based on infinite new question-answer requirements, to satisfy the new question-answer requirements by deploying the second model online in time.

This not only needs a model parameter and a scale that cannot be excessively large, but also needs the training sample to be quickly and timely constructed for training. In other words, even if the second model satisfies quickness and accuracy requirements of a question-answer task such as the intelligent customer service, a generation speed of the training sample needs to keep up with an iteration speed of the new question-answer requirement. However, in a related technology, corpus operations rely on labor. This is contradictory to the high efficiency and the timeliness needed for the intelligent customer service. However, the first model is introduced in this disclosure, to effectively improve training sample generation and generalization efficiency.

When the question-answer interaction service is provided for the question-answer task, the corpus database needs to be constructed to train the corresponding second model with a small scale, and the standard question, the similar question whose text similarity with the standard question satisfies the similarity condition, and the answer corresponding to the standard question are determined based on the original data related to the question-answer task by using the first model with a large scale. In comparison with the second model, the model service provided by the first model is not limited to the knowledge of the used training sample, and has the highly efficient semantic understanding and summarization capabilities, so that the standard question and the answer can be accurately extracted from the original data, and the similar question that conforms to a language expression habit can be created based on the text similarity. The corpus database is generated based on the corpus including the standard question, the similar question, and the answer, and the second model is trained based on the corpus database. The second model only needs to provide the question-answer interaction service within the knowledge of the used training sample, and a high-quality corpus with accuracy and comprehensiveness can be obtained through extraction and creation by using the first model. This reduces impact of high costs and quality fluctuation brought by manual maintenance, so that the second model can generate a high-quality reply answer to the user question obtained from the question-answer task, and building efficiency and updating efficiency of the corpus database can be effectively improved by using the first model.

The obtained original data carries a proportion of non-substantive content, for example, a modal particle, an image, an expression, and a link, of the historical question-answer text data. The non-substantive content provides no assistance for the first model in generation of the standard question and the answer, and instead, increases an unnecessary computing amount.

Therefore, in an implementation example, S202 of determining, based on the original data, a corresponding initial corpus by using the first model includes:

S2021: Perform data filtering on the original data to filter out, from the original data, an invalid text unrelated to the question-answer task, to obtain first text data.

S2022: Perform keyword recognition on the first text data, and filter out object information including a keyword from the first text data, to obtain second text data.

S2023: Determine an initial corpus corresponding to the second text data by using the first model.

The invalid text that is filtered out by a server from the original data through data filtering belongs to a text unrelated to the question-answer task, for example, the foregoing non-substantive content. Such invalid text accounts for a large proportion of the historical question-answer text data.

For example, the following are original data in various formats:

{“MsgType”: 4, “Rich”: [{“MsgType”: 1, “Content”: “[Rose] Haha, I'd like to make an inquiry about how to extract an intelligent customer service corpus”}]}

{“MsgType”: 4, “Rich”: [{“MsgType”: 2, “Url”: “https://www. xxxx. pn g”}]}

“[Fist-and-palm salute], understood, a corpus includes a standard question, a similar question, and an answer, thank you very much”.

The first text data obtained through data filtering is:

[“I'd like to make an inquiry about how to extract an intelligent customer service corpus”, “a corpus includes a standard question, a similar question, and an answer”].

In addition to a need to filter out such invalid text, this embodiment of this disclosure also takes into account removal of sensitive information. If such information is learned by the second model, the information may appear as an answer in a question-answer interaction scenario, resulting in leakage of the sensitive information.

Therefore, in this disclosure, desensitization processing is performed on the first text data through keyword recognition. The keyword used in the keyword recognition may be preset based on the sensitive information. In other words, the keyword may be customized for recognition of the first text data based on different desensitization requirements.

The server may precisely recognize, in the first text data in a keyword matching manner, for example, content matching or regular matching, the object information related to the keyword, that is, determine object information related to sensitive content, and filter out the object information from the first text data, to obtain the second text data.

The second text data is text data from which the invalid content and the sensitive information are removed. For the first model, this can effectively improve model processing efficiency and reduce occupation of model resources.

The text similarity is a basis for determining, by the server, the similar question based on the standard question, and may represent a similarity between the standard question and the similar question in a text dimension. When a text similarity between two question sentences reaches a similarity condition, it may be determined that inquiry requirements of the two question sentences are similar.

In this embodiment of this disclosure, the text similarity may be expressed by using a plurality of dimensions. For example, in an implementation example, the text similarity includes at least one of a semantic similarity and a representation similarity.

The semantic similarity is configured for identifying a similarity between two question sentences in a semantic level. A higher semantic similarity indicates closer meanings expressed by the two question sentences.

The representation similarity is configured for identifying a similarity between two question sentences in a sentence structure level. A higher representation similarity indicates a higher similarity between sentence structures of the two question sentences.

When the text similarity includes the semantic similarity, the similarity condition is that the semantic similarity is greater than a first similarity threshold.

When the text similarity includes the representation similarity, the similarity condition is that the representation similarity is less than a second similarity threshold.

In other words, when the text similarity is determined from a semantic dimension, the more semantically similar the better. In this way, inquiry requirements expressed by the similar question and the standard question are close to be consistent. When the text similarity is determined from a representational dimension, the more dissimilar the sentence structure is, the better. In this way, the similar question can be different from the standard question in the sentence structure, to carry richer information for model training.

Because quality of the second model directly depends on quality of the corpus database, maintenance of the corpus database includes maintenance of the quality of the corpus database.

The standard question is more important in the corpus database, and quality of the standard question directly affects quality of the similar question determined based on the text similarity. Therefore, in an implementation example, after S204 of generating a corpus database based on the initial corpus and the similar question corresponding to the standard question in the initial corpus, the method further includes:

S11: Use any two standard questions in the corpus database as a standard question pair, and determine a semantic similarity between the two standard questions.

S12: Adjust, in response to that the semantic similarity between the two standard questions is greater than an adjustment threshold, two corpora to which the two standard questions belong in the corpus database, to adjust the two corpora into one corpus.

For standard questions, different standard questions are to reflect different inquiry requirements. Otherwise, a relationship between a standard question and a standard question is not satisfied, but a relationship between a standard question and a similar question is satisfied. In other words, the standard questions need to be distinguished from each other. When the inquiry requirements expressed by the standard questions are excessively close, confusion may occur on the second model in a model training process. It is difficult to distinguish which standard question a question inputted by the user corresponds to based on learned knowledge. Because different standard questions correspond to different answers, the second model may reply with an incorrect answer.

However, when the standard question corresponding to the original data is generated by using the first model, generation of a standard question may not make excessive reference to another already generated standard question. Therefore, to improve the quality of the corpus database, quality detection may be performed on the standard question in the corpus database by using the semantic similarity.

When the semantic similarity between the two standard questions in the standard question pair is less than or equal to the adjustment threshold, for example, 0.9, the server determines that inquiry requirements expressed by the two standard questions are sufficiently distinguishable, and the two standard questions can be effectively applied to training of the second model.

When the semantic similarity between the two standard questions in the standard question pair is greater than the adjustment threshold, for example, 0.9, the server determines that the inquiry requirements expressed by the two standard questions are insufficiently distinguishable. If both the two standard questions are used as training samples to train the second model, confusion may occur on the second model for the two standard questions, resulting in reduction of model precision. In this case, the server may adjust the two corpora to which the two standard questions belong, to adjust the two corpora into one corpus, for example, delete one of the standard questions, or reconstruct one unified standard question based on the two standard questions. An adjustment manner is not limited herein.

Quality detection is performed on the standard question in the corpus database based on the semantic similarity, so that a standard question whose inquiry requirement is difficult to distinguish can be effectively removed, thereby improving the quality of the corpus database and further facilitating improvement of training quality of the second model.

In this disclosure, the original data may be updated over time, and in the data processing method provided in embodiments of this disclosure, a new standard question, similar question, and answer may be determined based on updated original data. The newly determined standard question, similar question, and answer can be configured for generating a new corpus, and the corpus is added as an incremental corpus to the already established corpus database, and is configured for generating a new training sample for iterative updating of the second model, thereby enabling the second model to learn knowledge corresponding to a new inquiry requirement in time and to provide a question-answer interaction service with high timeliness.

In other words, the new corpus may be added to the corpus database for the second model at any time. For the standard question in the corpus, the foregoing problem also needs to be addressed so as to avoid a problem in which confusion occurs on the inquiry requirement.

Therefore, in an implementation example, after S204 of generating a corpus database based on the initial corpus and the similar question corresponding to the standard question in the initial corpus, the method further includes:

S21: Determine, based on the updated original data, a corresponding to-be-determined initial corpus by using the first model.

S22: In response to that a semantic similarity between a to-be-determined standard question in the to-be-determined initial corpus and a target standard question in the corpus database is greater than an adjustment threshold, update, based on the to-be-determined initial corpus, a corpus to which the target standard question belongs.

S23: Determine, in response to that a semantic similarity between the to-be-determined standard question in the to-be-determined initial corpus and any standard question in the corpus database is less than or equal to the adjustment threshold, that the to-be-determined standard question satisfies a condition for adding to the corpus database, use the to-be-determined initial corpus as the initial corpus, and perform the operation of determining, based on the standard question, a corresponding similar question by using the first model.

In comparison with the existing standard question in the corpus database, when the to-be-determined standard question serving as an incremental standard question has the semantic similarity less than or equal to the adjustment threshold, for example, 0.9, the server may determine that an inquiry requirement of the to-be-determined standard question is distinguishable from all inquiry requirements in the current corpus database, and the to-be-determined standard question can be added to the corpus database as a new standard question. In this case, the similar question may be generated and the corpus may be constructed based on the to-be-determined standard question.

When the semantic similarity between the to-be-determined standard question serving as the incremental standard question and a standard question (denoted as the target standard question) in the corpus database is greater than the adjustment threshold, for example, 0.9, the server may determine that the inquiry requirement of the to-be-determined standard question and an inquiry requirement of the target standard question are not sufficiently distinguishable, and actually, the to-be-determined standard question and the target standard question are to be used as one standard question. In this case, the to-be-determined initial corpus is not used as an independent corpus, but is required to be updated into a corpus related to the target standard question as a supplement to the corpus. After the update, there is still only one standard question in the corpus. For a manner in which the to-be-determined standard question and the target standard question are updated into one standard question, refer to the foregoing implementation. Details are not repeated herein.

Quality detection is performed on the incremental standard question in the corpus database by using the semantic similarity, so that a case in which a standard question whose inquiry requirement is difficult to distinguish is added to the corpus database may be effectively avoided, thereby improving the quality of the corpus database, and further improving the training quality of the second model.

Because the training sample may also be generated based on the similar question, in addition to the standard question that is in the corpus database and whose quality needs to be detected, the similar question is also an important part affecting training precision of the second model, and quality detection needs to be effectively performed. The server generates the similar question corresponding to the standard question according to the text similarity, so that quality of the similar question relative to that of the standard question may be effectively ensured. However, similar questions in different corpora may have a problem.

In an implementation example, after S204 of generating a corpus database based on the initial corpus and the similar question corresponding to the standard question in the initial corpus, the method further includes:

S31: Select (e.g., randomly) a first corpus and a second corpus from the corpus database.

S32: Determine a text similarity between a similar question in the first corpus and a similar question in the second corpus.

S33: Determine, in response to that the text similarity between the similar question in the first corpus and the similar question in the second corpus satisfies a similar question confusion condition, that there is a confusion problem between the first corpus and the second corpus, and move the first corpus and the second corpus out of the corpus database.

It is found in this disclosure that there may be confusion that is based on a text similarity occurs between similar questions corresponding to different standard questions. A reason is that the similar question is determined based on the text similarity between the similar question and the standard question, and in a determining process, only the text similarity between the standard question and the similar question is considered. When a semantic similarity between two standard questions (from different corpora) is high but does not reach an adjustment threshold, similar questions respectively corresponding to the two standard questions may be close to each other in terms of the text similarity. If recognition is not performed, a problem in which the two corpora are confused with each other may occur on the second model during training, for example, generating the training sample by using the similar question.

Consequently, when the second model processes a user question inputted by the user, it is assumed that the user question relates to a corpus a. However, because a text similarity between a similar question in the corpus a and a similar question in a corpus b satisfies a similar question confusion condition, the second model learns incorrect knowledge during training, and may use an answer of the corpus b as a reply to the user question, causing intelligent question-answer interaction that cannot satisfy a user requirement.

Therefore, in this disclosure, similar question recognition is performed on corpora in the corpus database in a pairwise manner. A text similarity between similar questions in different corpora is determined, so that a similar question that may cause the foregoing problem may be recognized based on a similar question confusion condition. For example, in response to that the text similarity between the similar questions satisfies the similar question confusion condition, it is determined that there is the confusion problem between the first corpus and the second corpus. The server may move the first corpus and the second corpus out of the corpus database, to avoid a case in which the second model learns inappropriate knowledge by using training samples generated by using the first corpus and the second corpus.

The first corpus and the second corpus that are moved out of the corpus database may be processed. For example, the two corpora are combined, or the similar questions in the two corpora are adjusted. When a condition for adding to the corpus database is satisfied again, the corpora may be added to corpus database again.

After the corpus is determined by using the first model, resolvability of the corpus applied to a question-answer interaction scenario further needs to be determined. The resolvability may be configured for identifying whether an inquiry requirement of the user can be resolved through intelligent question-answer interaction. When resolvability of a corpus is insufficient, even if the second model learns related knowledge by using the corpus, a given reply answer still hardly satisfies the inquiry requirement that is of the user and that is related to the corpus.

Therefore, for a corpus having insufficient resolvability, even if quality of the corpus can pass the quality detection in the foregoing embodiment, the corpus still cannot be configured for training the second model, in other words, has little significance for training the second model.

Therefore, to improve the quality of the corpus configured for training the second model, another corpus that is prone to be confused with the corpus having the insufficient resolvability needs to be accurately filtered out.

Therefore, in an implementation example, after S204 of generating a corpus database based on the initial corpus and the corresponding similar question, the method further includes:

S41: Classify the corpora in the corpus database into a resolvable corpus set and an unresolvable corpus set based on the resolvability of the corpora applied to the question-answer interaction scenario, the resolvable corpus set including a first standard question, and the unresolvable corpus set including a second standard question.

S42: Determine a text similarity between the first standard question and the second standard question.

S43: Determine, in response to that the text similarity between the first standard question and the second standard question satisfies a standard question confusion condition, that a corpus to which the first standard question belongs has a confusion problem, and move, out of the corpus database, the corpus to which the first standard question belongs.

According to a degree of the resolvability, the corpora in the corpus database may be classified into the resolvable corpus set and the unresolvable corpus set, resolvability of a corpus in the resolvable corpus set satisfies a requirement of the question-answer interaction scenario, and resolvability of a corpus in the unresolvable corpus set does not satisfy the requirement of the question-answer interaction scenario. Classification of the resolvable corpus set and the unresolvable corpus set may be implemented based on a resolvability threshold. The resolvability threshold may be set based on experience, or may be set based on interaction precision of the question-answer interaction scenario. This is not limited in this disclosure.

A standard question in the resolvable corpus set may be considered as a resolvable standard question, and a standard question in the unresolvable corpus set may be considered as an unresolvable standard question. The resolvable standard question refers to a standard question that can be resolved by an existing corpus database, and the unresolvable standard question refers to that a standard question can be resolved only by manual intervention, and cannot be resolved by the existing corpus database. If a similarity between the resolvable standard question and the unresolvable standard question is excessively high, first, it may be difficult for a subsequent text classification model to classify samples properly; and second, from a perspective of services, the resolvable standard question and the unresolvable standard question belong to different service domains, and corpora of the two are not to have an excessively high similarity. If highly similar corpora appear, the corpora are to be obtained through detection and flagged for confirmation by relevant personnel.

For the first standard question in the resolvable corpus set and the second standard question in the unresolvable corpus set, the server may determine the text similarity between the first standard question and the second standard question, and determine whether the first standard question has the confusion problem based on a relationship between the text similarity and the standard question confusion condition. In addition, when it is determined that the standard question confusion condition is satisfied, the corpus to which the first standard question belongs is moved out of the corpus database, thereby improving corpus quality of the corpus database.

As described above, to avoid underfitting, a specific quantity of similar questions needs to be reached in the corpus. However, after the foregoing quality detection, it is possible that a quantity of similar questions in a corpus is insufficient to satisfy a requirement on training. Therefore, before the corpus in the corpus database is configured for training, whether the quantity of similar questions in the corpus reaches a standard needs to be determined.

Therefore, in an implementation example, before S205 of training the second model by using the training sample, the method further includes:

S51: Determine a quantity of similar questions included in the corpora in the corpus database.

S52: In response to that the quantity of similar questions included in the corpora is a target quantity less than that required for training, determine, based on the standard question in the corpora, the target quantity of similar questions by using the first model.

When the server finds that the quantity of similar questions in the corpora is insufficient, the server may generate, by using the first model, a needed quantity of similar questions based on the standard question in the corpus in a manner of S203, to add the similar questions to the corpora.

In this way, quality of a target corpus can be effectively improved, and occurrence of training underfitting can be reduced.

To intuitively reflect a status of the corpus database and for ease of maintenance, in an implementation example, the method further includes:

S61: Determine a quality parameter of the similar question in the corpus based on the text similarity between the similar questions in the corpus.

S62: Display the corpus and the quality parameter on a corpus management interface.

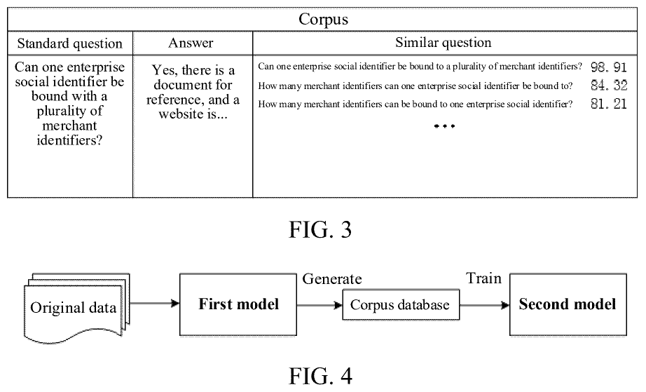

As shown in FIG. 3, FIG. 3 shows content included in a corpus. The content includes:

Standard question: “Can one enterprise social identifier be bound with a plurality of merchant identifiers?”

Answer: “Yes, there is a document for reference, and a website is . . . ”

Similar question: “Can one enterprise social identifier be bound to a plurality of merchant identifiers?”, “How many merchant identifiers can one enterprise social identifier be bound to?”, “How many merchant identifiers can be bound to one enterprise social identifier?”, and the like.

A quality parameter, such as 98.81 or 84.32, determined based on a text similarity between the similar question and the standard question is displayed for each similar question. A larger parameter value indicates that the text similarity between the similar question and the standard question satisfies a similarity condition.

By displaying the quality parameter, similar question quality of a corpus can be intuitively reflected, thereby facilitating subsequent maintenance.

FIG. 4 is a schematic diagram of providing a corpus database for a small model (that is, a second model) based on a large model (that is, a first model), so that efficient operation of a corpus based on the large model can be implemented.

A server automatically extracts a standard question and a similar question from massive amounts of original data by using a capability of the large model, then automatically generalizes the standard question in batches to obtain a sufficient quantity of similar questions, and may further support quality detection on the standard question and the similar questions, thereby effectively improving a training and iteration speed of the small model, and improving operation efficiency and quality of an intelligent customer service.

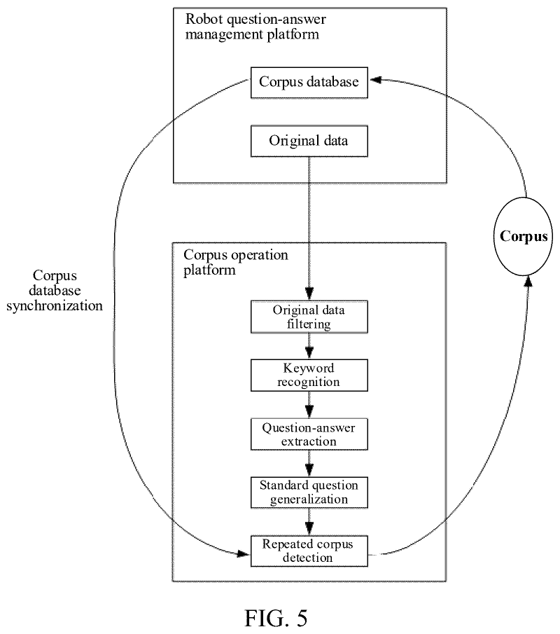

FIG. 5 is a schematic diagram of corpus generation of a robot question-answer platform, including a robot question-answer management platform and a corpus operation platform.

The corpus operation platform may invoke a large model, to implement original data filtering, keyword recognition, question-answer extraction, standard question generalization, and repeated corpus detection. A corpus database is maintained in the robot question-answer management platform, to train, iterate, and update a small model, and the small model is configured for providing a function of an intelligent customer service for the robot question-answer management platform. The robot question-answer management platform may further collect related original data in real time and provide the related original data to the corpus operation platform.

Original data filtering:

Based on a service characteristic, a significant courtesy expression, a meaningless word, an emoji, and an image link, for example, various emojis and modal particles such as “haha”, are filtered out and removed. After the original data is integrated and filtered out, a piece of easily analyzed data may be obtained, and the data is detonated as first text data.

Keyword recognition:

A keyword can be customized. Data with the customized keyword can be precisely recognized and hit by performing content matching or regular matching on the first text data, and can be removed, to obtain second text data.

Question-answer extraction:

The question-answer extraction is mainly to analyze the original data or the second text data by using a large model capability, and a standard question and an answer can be effectively extracted by using context understanding, semantic analysis, and summary extraction capabilities of the large model and adjusting a model parameter with reference to an appropriate prompt.

Standard question generalization:

After the question-answer extraction is completed, the extracted standard question further needs to be generalized. Therefore, the small model is enabled to hit a question asked by a user more accurately when more similar questions are extracted from the standard question to enrich a corpus database. Then, a corresponding answer (solution) is provided. Herein, a capability of the large model is alternatively used, and a temperature of the model is adjusted to a high value, to control diversity and randomness of a result of the generated similar question, so as to better satisfy expectation on diversity and randomness of the user question.

Repeated corpus detection:

Based on the foregoing principle of corpus quality measurement, text similarity computing may be performed in a plurality of forms, as shown below.

Representation similarity: The representation similarity may be determined by using a Hamming distance, a Levenshtein distance, a Euclidean distance, or a Manhattan distance.

Semantic similarity: The semantic similarity may be determined by using a CoSENT text matching model, a BERT model (text vector representation), or a SentenceBERT text matching model.

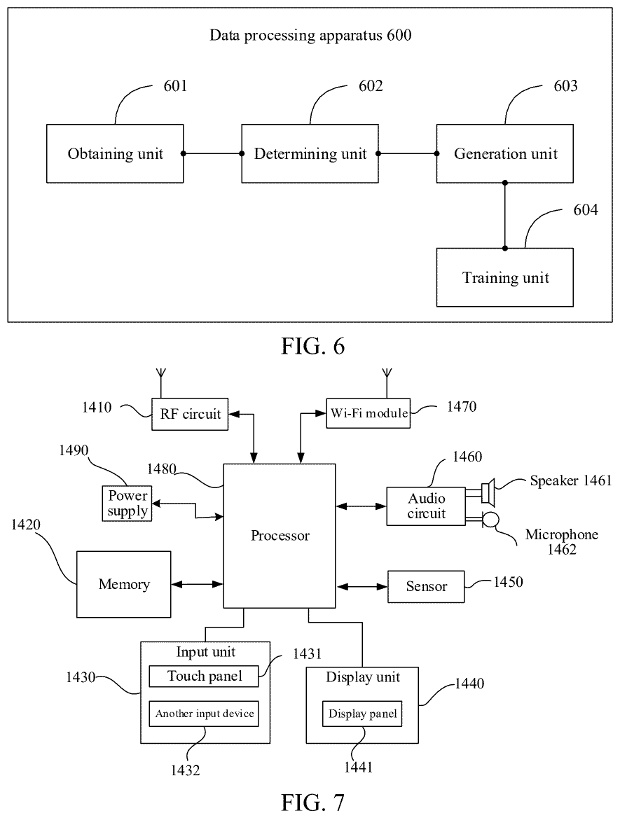

Based on embodiments corresponding to FIG. 1 to FIG. 5, FIG. 6 is a diagram of an apparatus structure of a data processing apparatus according to an embodiment of this disclosure. The data processing apparatus 600 includes an obtaining unit 601, a determining unit 602, a generation unit 603, and a training unit 604.

The obtaining unit 601 is configured to obtain original data related to a question-answer task.

The determining unit 602 is configured to determine, based on the original data, a corresponding initial corpus by using a first model, the initial corpus including a standard question and an answer corresponding to the standard question.

The determining unit 602 is further configured to determine, based on the standard question, a corresponding similar question by using the first model, a text similarity between the similar question and the standard question that have a correspondence satisfying a similarity condition.

The generation unit 603 is configured to generate a corpus database based on the initial corpus and the similar question corresponding to the standard question in the initial corpus, corpora in the corpus database including the standard question, the answer corresponding to the standard question, and the similar question, the corpora in the corpus database being used as a training sample to train a second model configured for performing the question-answer task, a scale of the second model being smaller than that of the first model, the standard question or the similar question in the training sample being used as an input of the second model, and the answer corresponding to the standard question in the training sample being used as a sample label.

The training unit 604 is configured to train the second model by using the training sample, a trained second model being configured for generating a corresponding reply answer to a user question obtained from the question-answer task.

In an implementation example, the determining unit is further configured to:

perform data filtering on the original data to filter out, from the original data, an invalid text unrelated to the question-answer task, to obtain first text data;

perform keyword recognition on the first text data, and filter out object information including a keyword from the first text data, to obtain second text data; and

determine an initial corpus corresponding to the second text data by using the first model.

In an implementation example, the original data includes at least one of historical question-answer text data and field knowledge text data related to the question-answer task.

In an implementation example, the text similarity includes at least one of a semantic similarity and a representation similarity.

When the text similarity includes the semantic similarity, the similarity condition is that the semantic similarity is greater than a first similarity threshold.

When the text similarity includes the representation similarity, the similarity condition is that the representation similarity is less than a second similarity threshold.

In an implementation example, the determining unit is further configured to:

use any two standard questions in the corpus database as a standard question pair, and determine a semantic similarity between the two standard questions; and po adjust, in response to that the semantic similarity between the two standard questions is greater than an adjustment threshold, two corpora to which the two standard questions belong in the corpus database, to adjust the two corpora into one corpus.

In an implementation example, the determining unit is further configured to:

determine, based on updated original data, a corresponding to-be-determined initial corpus by using the first model;

in response to that a semantic similarity between a to-be-determined standard question in the to-be-determined initial corpus and a target standard question in the corpus database is greater than an adjustment threshold, update, based on the to-be-determined initial corpus, a corpus to which the target standard question belongs; and

determine, in response to that a semantic similarity between the to-be-determined standard question in the to-be-determined initial corpus and any standard question in the corpus database is less than or equal to the adjustment threshold, that the to-be-determined standard question satisfies a condition for adding to the corpus database, use the to-be-determined initial corpus as the initial corpus, and perform the operation of determining, based on the standard question, a corresponding similar question by using the first model.

In an implementation example, the determining unit is further configured to:

randomly select a first corpus and a second corpus from the corpus database;

determine a text similarity between a similar question in the first corpus and a similar question in the second corpus; and

determine, in response to that the text similarity between the similar question in the first corpus and the similar question in the second corpus satisfies a similar question confusion condition, that there is a confusion problem between the first corpus and the second corpus, and move the first corpus and the second corpus out of the corpus database.

In an implementation example, the determining unit is further configured to:

classify the corpora in the corpus database into a resolvable corpus set and an unresolvable corpus set based on resolvability of the corpora applied to a question-answer interaction scenario, the resolvable corpus set including a first standard question, and the unresolvable corpus set including a second standard question;

determine a text similarity between the first standard question and the second standard question; and

determine, in response to that the text similarity between the first standard question and the second standard question satisfies a standard question confusion condition, that a corpus to which the first standard question belongs has a confusion problem, and move, out of the corpus database, the corpus to which the first standard question belongs.

In an implementation example, the determining unit is further configured to:

determine a quantity of similar questions included in the corpora in the corpus database; and

in response to that the quantity of similar questions included in the corpora is a target quantity less than that required for training, determine, based on the standard question in the corpora, the target quantity of similar questions by using the first model.

In an implementation example, the apparatus further includes a display unit, and the display unit is configured to:

determine a quality parameter of the similar question in the corpus based on a text similarity between similar questions in the corpus; and

display the corpus and the quality parameter on a corpus management interface.

Embodiments of this disclosure further provide a computer device. The computer device is the foregoing computer device, and may include a terminal device or a server. The foregoing data processing apparatus may be configured in the computer device. The following describes the computer device with reference to the accompanying drawings.

If the computer device is a terminal device, refer to FIG. 7. Embodiments of this disclosure provide a terminal device. An example in which the terminal device is a mobile phone is used.

FIG. 7 is a block diagram of a part of a structure of the mobile phone related to the terminal device according to an embodiment of this disclosure. Refer to FIG. 7. The mobile phone includes components such as a radio frequency (referred to as RF for short) circuit 1410, a memory 1420, an input unit 1430, a display unit 1440, a sensor 1450, an audio circuit 1460, a wireless fidelity (referred to as Wi-Fi for short) module 1470, a processor 1480, and a power supply 1490. It is noted that the structure, shown in FIG. 7, of the mobile phone does not constitute a limitation on the mobile phone, and the mobile phone may include more or fewer components than those shown in the figure, or a combination of some components, or a different component deployment may be used.

The following describes the components of the mobile phone with reference to FIG. 7.

The RF circuit 1410 may be configured to receive and transmit a signal during an information receiving and transmitting process or a conversation process. In some examples, the RF circuit 1410 receives downlink information from a base station, and then delivers the downlink information to the processor 1480 for processing. In addition, the RF circuit 1410 transmits related uplink data to the base station.

The memory 1420 may be configured to store a software program and a module. The processor 1480 runs the software program and the module that are stored in the memory 1420, to perform various functional applications and data processing of the mobile phone. The memory 1420 may mainly include a program storage area and a data storage area. The program storage area may store an operating system, an application program required by at least one function (such as a sound playback function and an image display function), and the like. The data storage area may store data (such as audio data and a phonebook) created according to use of the mobile phone, and the like. In addition, the memory 1420 may include a high speed random access memory, and may alternatively include a non-volatile memory, such as at least one magnetic disk storage device, a flash memory, or another volatile solid-state storage device.

The input unit 1430 may be configured to receive inputted digit or character information, and generate a keyboard signal input related to user settings and function control of the mobile phone. In some examples, the input unit 1430 may include a touch panel 1431 and another input device 1432.

The display unit 1440 may be configured to display information inputted by a user or information provided for the user, and various menus of the mobile phone. The display unit 1440 may include a display panel 1441.

The mobile phone may further include at least one sensor 1450, such as an optical sensor, a motion sensor, and another sensor.

The audio circuit 1460, a speaker 1461, and a microphone 1462 may provide audio interfaces between the user and the mobile phone.

Wi-Fi is a short-distance wireless transmission technology. The mobile phone may help, by using the Wi-Fi module 1470, the user to receive and transmit an email, browse a web page, access stream media, and the like, to allow wireless broadband Internet access of the user.

The processor 1480 is a control center of the mobile phone, and is connected to various parts of the entire mobile phone via various interfaces and lines. Various functions of the mobile phone and data processing are performed by running or executing the software program and/or the module stored in the memory 1420 and invoking data stored in the memory 1420.

The mobile phone further includes the power supply 1490 (such as a battery) for supplying power to the components.

In this embodiment, the processor 1480 included in the terminal device is further configured to perform the data processing method provided in embodiments of this disclosure.

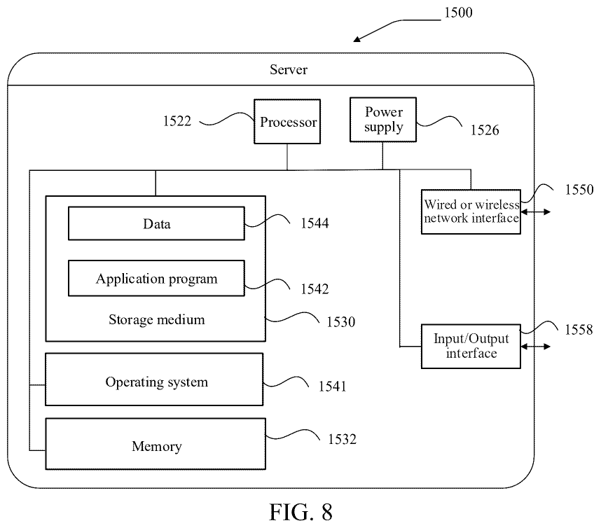

If the computer device is a server, embodiments of this disclosure further provide a server. Refer to FIG. 8. FIG. 8 is a structural diagram of a server 1500 according to an embodiment of this disclosure. The server 1500 greatly differs due to different configurations or performances. The server 1500 may include one or more central processing units (referred to as CPUs for short) 1522 (for example, one or more processors), a memory 1532, and one or more storage media 1530 (for example, one or more mass storage devices) for storing applications 1542 or data 1544. The memory 1532 and the storage medium 1530 may be configured for temporary storage or persistent storage. A program stored in the storage medium 1530 may include one or more modules (not shown in the figure). Each module may include a series of instruction operations on the server. Further, the central processing unit 1522 may be configured to communicate with the storage medium 1530, and perform, on the server 1500, the series of instruction operations in the storage medium 1530.

The server 1500 may further include one or more power supplies 1526, one or more wired or wireless network interfaces 1550, one or more input/output interfaces 1558, and/or one or more operating systems 1541 such as Windows Server™, Mac OS X™, Unix™, Linux™, or FreeBSD™.

Operations performed by the server in the foregoing embodiments may be based on the server structure shown in FIG. 8.

In addition, embodiments of this disclosure further provide a storage medium. The storage medium is configured to store a computer program, and the computer program is configured for performing the method provided in the foregoing embodiments.

Embodiments of this disclosure further provide a computer program product including a computer program. The computer program, when run on a computer device, causes the computer device to perform the method provided in the foregoing embodiments.

It is noted that all or some of the steps of the method embodiments may be implemented by a program instructing relevant hardware. The program may be stored in a computer-readable storage medium. When the program is run, the steps of the method embodiments are performed. The foregoing storage medium may be at least one of the following media: any medium that can store a computer program, such as a read-only memory (ROM), a RAM, a magnetic disk, or an optical disc.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of data processing, comprising:
obtaining original data related to a question-answer task;
determining, based on the original data, at least an initial corpus by using a first model, the initial corpus comprising a standard question and an answer to the standard question;
determining, by using the first model, at least a similar question based on the standard question, a text similarity between the similar question and the standard question satisfying a similarity condition;
generating a corpus database based on at least the initial corpus and the similar question, the corpus database comprising at least a corpus that includes the standard question, the answer to the standard question, and at least the similar question; and
training a second model for performing the question-answer task by using at least the corpus as a training sample, the second model having a smaller scale than the first model, the standard question or the similar question being used as an input of the second model, and the answer to the standard question being used as a sample label.

2. The method according to claim 1, wherein the determining the initial corpus comprises:
filtering the original data to exclude at least an invalid text unrelated to the question-answer task to obtain first text data;
performing keyword recognition on the first text data to obtain a keyword;
filtering out, from the first text data, object information comprising the keyword, to obtain second text data; and
determining the initial corpus from the second text data by using the first model.

3. The method according to claim 1, wherein the original data comprises at least one of historical question-answer text data and field knowledge text data related to the question-answer task.

4. The method according to claim 1, wherein:
the text similarity comprises at least one of a semantic similarity and a representation similarity;
when the text similarity comprises the semantic similarity, the similarity condition includes that the semantic similarity is greater than a first similarity threshold; and
when the text similarity comprises the representation similarity, the similarity condition includes that the representation similarity is less than a second similarity threshold.

5. The method according to claim 1, the method further comprising:
forming a standard question pair with two standard questions in the corpus database, the two standard questions respectively belonging to two corpora in the corpus database;
determining a semantic similarity between the two standard questions; and
when the semantic similarity between the two standard questions is greater than an adjustment threshold, adjusting the corpus database, the two corpora being adjusted into one corpus in the corpus database.

6. The method according to claim 1, the method further comprising:
determining, based on an update to the original data, a to-be-determined initial corpus by using the first model, the to-be-determined initial corpus comprising a to-be-determined standard question;
when a semantic similarity between the to-be-determined standard question in the to-be-determined initial corpus and a target standard question of a target corpus in the corpus database is greater than an adjustment threshold, updating, based on the to-be-determined initial corpus, the target corpus; and
when a semantic similarity between the to-be-determined standard question and respective standard question in the corpus database is less than or equal to the adjustment threshold,
determining that the to-be-determined standard question satisfies a condition for adding to the corpus database; and
updating the corpus database with a new corpus that includes the to-be-determined initial corpus and at least a similar question to the to-be-determined standard question, the similar question to the to-be-determined standard question being determined based on the to-be-determined standard question by using the first model.

7. The method according to claim 1, the method further comprising:
selecting a first corpus and a second corpus from the corpus database, the first corpus comprising a first standard question and at least a first similar question to the first standard question, the second corpus comprising a second standard question and at least a second similar question to the second standard question;
determining a text similarity between the first similar question in the first corpus and the second similar question in the second corpus; and
when the text similarity between the first similar question in the first corpus and the second similar question in the second corpus satisfies a similar question confusion condition, moving the first corpus and the second corpus out of the corpus database.

8. The method according to claim 1, the method further comprising:
classifying corpora in the corpus database into a resolvable corpus set and an unresolvable corpus set based on resolvability of the corpora in a question-answer interaction scenario, the resolvable corpus set comprising at least a first corpus that includes a first standard question, and the unresolvable corpus set comprising at least a second corpus that includes a second standard question;
determining a text similarity between the first standard question and the second standard question; and
when the text similarity between the first standard question and the second standard question satisfies a standard question confusion condition, moving the first corpus out of the corpus database.

9. The method according to claim 1, the method further comprising:
determining a quantity of similar questions in the corpus in the corpus database; and
when the quantity of similar questions is less than a required number for training by a target quantity, determining, based on the standard question in the corpus, the target quantity of similar questions by using the first model.

10. The method according to claim 1, the method further comprising:
determining respective quality parameters of a plurality of similar questions in the corpus based on respective text similarities of the plurality of similar questions in the corpus to the standard question in the corpus; and
displaying the corpus and the respective quality parameters of the plurality of similar questions in the corpus on a corpus management interface.

11. An apparatus of data processing, comprising processing circuitry configured to:
obtain original data related to a question-answer task;
determine, based on the original data, at least an initial corpus by using a first model, the initial corpus comprising a standard question and an answer to the standard question;
determine, by using the first model, at least a similar question based on the standard question, a text similarity between the similar question and the standard question satisfying a similarity condition;
generate a corpus database based on at least the initial corpus and the similar question, the corpus database comprising at least a corpus that includes the standard question, the answer to the standard question, and at least the similar question; and
train a second model for performing the question-answer task by using at least the corpus as a training sample, the second model having a smaller scale than the first model, the standard question or the similar question being used as an input of the second model, and the answer to the standard question being used as a sample label.

12. The apparatus according to claim 11, wherein the processing circuitry is configured to:
filter the original data to exclude at least an invalid text unrelated to the question-answer task to obtain first text data;
perform keyword recognition on the first text data to obtain a keyword;
filter out, from the first text data, object information comprising the keyword, to obtain second text data; and
determine the initial corpus from the second text data by using the first model.

13. The apparatus according to claim 11, wherein the original data comprises at least one of historical question-answer text data and field knowledge text data related to the question-answer task.

14. The apparatus according to claim 11, wherein:
the text similarity comprises at least one of a semantic similarity and a representation similarity;
when the text similarity comprises the semantic similarity, the similarity condition includes that the semantic similarity is greater than a first similarity threshold; and
when the text similarity comprises the representation similarity, the similarity condition includes that the representation similarity is less than a second similarity threshold.

15. The apparatus according to claim 11, wherein the processing circuitry is configured to:
form a standard question pair with two standard questions in the corpus database, the two standard questions respectively belonging to two corpora in the corpus database;
determine a semantic similarity between the two standard questions; and
when the semantic similarity between the two standard questions is greater than an adjustment threshold, adjust the corpus database, the two corpora being adjusted into one corpus in the corpus database.

16. The apparatus according to claim 11, wherein the processing circuitry is configured to:
determine, based on an update to the original data, a to-be-determined initial corpus by using the first model, the to-be-determined initial corpus comprising a to-be-determined standard question;
when a semantic similarity between the to-be-determined standard question in the to-be-determined initial corpus and a target standard question of a target corpus in the corpus database is greater than an adjustment threshold, update, based on the to-be-determined initial corpus, the target corpus; and
when a semantic similarity between the to-be-determined standard question and respective standard question in the corpus database is less than or equal to the adjustment threshold,
determine that the to-be-determined standard question satisfies a condition for adding to the corpus database; and
update the corpus database with a new corpus that includes the to-be-determined initial corpus and at least a similar question to the to-be-determined standard question, the similar question to the to-be-determined standard question being determined based on the to-be-determined standard question by using the first model.

17. The apparatus according to claim 11, wherein the processing circuitry is configured to:
select a first corpus and a second corpus from the corpus database, the first corpus comprising a first standard question and at least a first similar question to the first standard question, the second corpus comprising a second standard question and at least a second similar question to the second standard question;
determine a text similarity between the first similar question in the first corpus and the second similar question in the second corpus; and
when the text similarity between the first similar question in the first corpus and the second similar question in the second corpus satisfies a similar question confusion condition, move the first corpus and the second corpus out of the corpus database.

18. The apparatus according to claim 11, wherein the processing circuitry is configured to:
classify corpora in the corpus database into a resolvable corpus set and an unresolvable corpus set based on resolvability of the corpora in a question-answer interaction scenario, the resolvable corpus set comprising at least a first corpus that includes a first standard question, and the unresolvable corpus set comprising at least a second corpus that includes a second standard question;
determine a text similarity between the first standard question and the second standard question; and
when the text similarity between the first standard question and the second standard question satisfies a standard question confusion condition, move the first corpus out of the corpus database.

19. The apparatus according to claim 11, wherein the processing circuitry is configured to:
determine a quantity of similar questions in the corpus in the corpus database; and
when the quantity of similar questions is less than a required number for training by a target quantity, determine, based on the standard question in the corpus, the target quantity of similar questions by using the first model.

20. A non-transitory computer-readable storage medium storing instructions which when executed by at least one processor cause the at least one processor to:
obtaining original data related to a question-answer task;
determining, based on the original data, at least an initial corpus by using a first model, the initial corpus comprising a standard question and an answer to the standard question;
determining, by using the first model, at least a similar question based on the standard question, a text similarity between the similar question and the standard question satisfying a similarity condition;
generating a corpus database based on at least the initial corpus and the similar question, the corpus database comprising at least a corpus that includes the standard question, the answer to the standard question, and at least the similar question; and
training a second model for performing the question-answer task by using at least the corpus as a training sample, the second model having a smaller scale than the first model, the standard question or the similar question being used as an input of the second model, and the answer to the standard question being used as a sample label.
